(19) United States
(12) Patent Application Publication
(10) Pub. No.: US 2020/0073890 A1
(43) Pub. Date: Mar. 5, 2020

(54) INTELLIGENT SEARCH PLATFORMS

(71) Applicant: Michael I. SHAMOS, Pittsburgh, PA (US)

(72) Inventor: Michael I. SHAMOS, Pittsburgh, PA (US)

(73) Assignee: Three10 Solutions, Inc., Pittsburgh, PA (US)

(21) Appl. No.: 16/548,624

(22) Filed: Aug. 22, 2019

Related U.S. Application Data
(60) Provisional application No. 62/721,220, filed on Aug. 22, 2018.

(51) Int. Cl. G06F 16/903; G06F 16/93; G06K 9/62; G06F 17/16

(52) U.S. Cl. CPC G06F 16/903; G06F 17/16; G06K 9/6215; G06F 16/93

(57) ABSTRACT

Systems and methods for performing searches using the natural written or spoken language of a search query's author are described herein.

### CROSS-REFERENCE TO RELATED APPLICATIONS

This application claims priority from U.S. Application No. 62/721,220 entitled “Intelligent Search Platforms,” filed Sep. 22, 2018, the entirety of which is hereby incorporated by reference.

### GOVERNMENT INTERESTS

Not applicable

### PARTIES TO A JOINT RESEARCH AGREEMENT

Not applicable

### INCORPORATION OF MATERIAL ON COMPACT DISC

Not applicable

### BACKGROUND

Not applicable

### SUMMARY OF THE INVENTION

Various embodiments are directed to a query composed of a first input describing a subject in natural language and a second input describing an individual element of the subject. In some embodiments, the query may be used to provide information to a computer program that can, for example, use the information to search a computerized database. In certain embodiments, the first input may be an abstract or other description of an object, article, apparatus, compound, method, or combinations thereof, and in some embodiments, the second input may be a detailed description of the individual element of the first input. In some embodiments, the first input, the second input or combination thereof may be in the form of a written language, a spoken language, or combinations thereof, and in particular embodiments, the second input may be in the form of a written language, a spoken language, a keyword, a Bollean, or combinations thereof.

Some embodiments are directed to methods including the steps of processing a first input describing a subject in natural language to produce a first series of vectors, processing a second input describing an individual element of the subject to produce a second series of vectors, comparing the first series of vectors to index vectors in an index derived from a database of documents, identifying documents that include similar vectors to the first series of vectors to produce a first set of documents, comparing the second series of vectors to the index vectors, identifying documents that include similar vectors to the second series of vectors to produce a second set of documents, combining the first set of documents and the second set of documents to produce a relevant set of documents. In certain embodiments, the first input may be an abstract or other description of an object, article, apparatus, compound, method, or combinations thereof, and in some embodiments, the second input may be a detailed description of the individual element of the first input. In some embodiments, the first input, the second input or combination thereof may be in the form of a written language, a spoken language, or combinations thereof, and in particular embodiments, the second input may be in the form of a written language, a spoken language, a keyword, a Bollean, or combinations thereof.

In some embodiments, the method may further include calculating a difference between the first set of vectors, the second set of vectors, or combinations thereof, and the index vectors to produce a score for each document of the first set of documents, each document of the second set of documents, or combinations thereof. In some embodiments, the method may further include the step of scoring the first set of documents and the first input to produce a series of first similarity scores and scoring the second set of documents and the second input to produce a series of second similarity scores, or combinations thereof. In some embodiments, such methods may further include multiplying the series of first similarity scores by a first weighting factor to produce a series of first weighted similarity scores, multiplying the series of second similarity scores by a second weighting factor to produce a series of second weighted similarity scores, or combinations thereof. In some embodiments, the first weighting factor and the second weighting factor may be the same, and in other embodiments, the first weighting factor and the second weighting factor may be different.

In some embodiments, processing may include the step of converting each word of each sentence of the first input, the second input, or combinations thereof to a vector to produce the first series of vectors, the second series of vectors, or combinations thereof, and in some embodiments, such methods may include the step of plotting the first series of vectors, the second series of vectors, or combinations thereof in vector space.

In various embodiments, the database of documents may include, for example, published articles, academic journals, patent publications, issued patents, and combinations thereof. In some embodiments, the methods may include converting each word of each sentence of each document of the database of documents to a vector to produce the index vectors, and in some embodiments, such methods may include plotting the index vectors in vector space.

In some embodiments, the methods may include the step of combining the first set of documents and the second set of documents to produce a relevant set of documents comprises ordering the series of first weighted similarity scores and the series of second weighted similarity scores and identifying the documents associated with each of the series of first weighted similarity scores and the series of second weighted similarity scores. In some embodiments, the methods may include the step of identifying documents that include similar vectors to the second series of vectors to produce the second set of documents is carried out before identifying documents that include similar vectors to the first series, and identifying documents that include similar vectors to the first series of vectors is carried out on the second set of documents. In particular embodiments, the methods may include the step of identifying documents that include similar vectors to the second series of vectors is carried out on the first set of documents.

### DESCRIPTION OF THE DRAWINGS

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in detail so as to not unnecessarily obscure the present invention.

FIG. 1 is a diagram showing an exemplary system for performing the methods discussed below.

FIG. 2 is a flowchart showing various methods discussed below.

### DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 μm to 8 μm is stated, 2 μm, 3 μm, 4 μm, 5 μm, 6 μm, and 7 μm are also intended to be explicitly disclosed, as well as the range of values greater than or equal to 1 μm and the range of values less than or equal to 8 μm.

All percentages, parts and ratios are based upon the total weight of the topical compositions and all measurements made are at about 25° C., unless otherwise specified.

The singular forms “a,” “an,” and “the” include plural referents unless the context clearly dictates otherwise. Thus, for example, reference to a “polymer” includes a single polymer as well as two or more of the same or different polymers; reference to an “excipient” includes a single excipient as well as two or more of the same or different excipients, and the like.

The word “about” when immediately preceding a numerical value means a range of plus or minus 10% of that value, e.g, “about 50” means 45 to 55, “about 25,000” means 22,500 to 27,500, etc, unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g, more than 49.5 to less than 52.5. Furthermore, the phrases “less than about” a value or “greater than about” a value should be understood in view of the definition of the term “about” provided herein.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, analogs, compounds, ligands, structures, or groups thereof, or any members of a claimed group, less than the full measure of this disclosure can be claimed for any reason. Throughout this disclosure, various patents, patent applications and publications are referenced. The disclosures of these patents, patent applications and publications in their entireties are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

The following detailed description of example implementations refers to the accompanying drawings. The same reference numbers in different drawings may identify the same or similar elements.

Much of the world's information or data is in the form of text, the majority of which is unstructured (without metadata or in that the substance of the content is not asymmetrical and unpredictable, i.e., prose, rather than formatted in predictable data tables). Much of this textual data is available in digital form, either originally created in this form or converted to digital by means of, for example, OCR (optical character recognition) and is stored and available via the Internet or other networks. Unstructured text is difficult to effectively handle in large volumes even when using state of the art processing capabilities. Content is outstripping the processing power needed to effectively manage and assimilate information from a variety of sources for refinement and delivery to users. Although advances have made it possible to investigate, retrieve, extract and categorize information contained in vast repositories of documents, files, or other text “containers,” systems are needed to more efficiently manage and classify the ever-growing volume of data generated daily and to more effectively deliver such information to consumers.

This proliferation of text-based information in electronic form has resulted in a growing need for tools that facilitate organization of the information and allow users to query systems for desired information. One such tool is information extraction software that, typically, analyzes electronic documents written in a natural language and populates a database with information extracted from such documents. Applied against a given textual document, the process of information extraction (IE) is used to identify entities of predefined types appearing within the text and then to list them, for example, people, companies, geographical locations, currencies, units of time, etc.). IE may also be applied to extract other words or terms or strings of words or phrases.

Knowledge workers, such as scientists, lawyers, traders, or accountants, have to deal huge amounts of data with increasing levels of variety. To satisfy these needs, information providers must pull information from wherever it happens to be stored and bring it together in a summary result. For example, a may need to compare patented inventions to new inventions or existing or contemplated products.

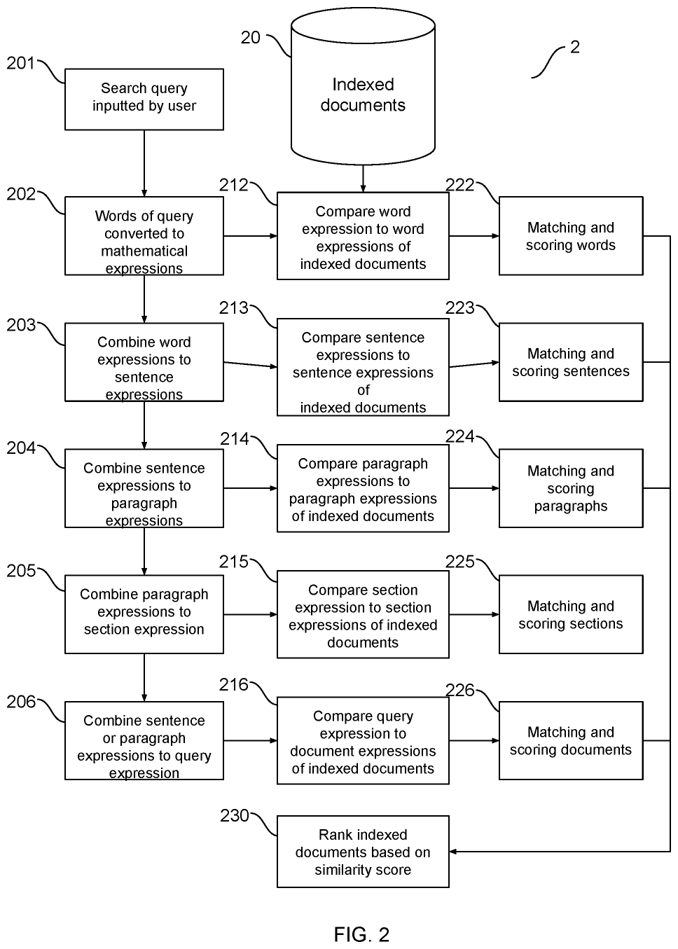

Various embodiments of the invention are directed to methods for carrying out a search using natural language processing and computer implemented methods for same. FIG. 2 is a flowchart 2 showing various embodiments of the invention. In some embodiments, the search is carried out based on a search query that can be a an abstract or other description of object, article, apparatus, compound, method, and the like and combinations thereof inputted in the users natural written or spoken language 201. The methods of such embodiments may include the step of converting each word of each sentence of the search query to a mathematical expression to produce a number of word mathematical expressions 202. In some embodiments, a step of comparing each word mathematical expression to word mathematical expressions of an index of words, paragraphs, or documents may be carried out 212. In other embodiments, the methods may include the step of combining the word mathematical expression of a sentence to produce a sentence mathematical expression 203, and the sentence mathematical expression may be compared to sentence mathematical expressions of an index of words, paragraphs, or documents 213. Such methods may further include the step of identifying of words, paragraphs, or documents in the index that include matched mathematical expressions.

The step of combining the word mathematical expression of a sentence to produce a sentence mathematical expression 203, in various embodiments, can be carried out by any means including, for example, averaging the word, sentence, or paragraph mathematical expression, adding the word, sentence, or paragraph mathematical expression, multiplying the word, sentence, or paragraph mathematical expressions, and the like and combinations thereof. Similarly, the step of comparing each word mathematical expression to word mathematical expressions of an index of words 212, sentences 213, paragraphs 214, sections 215, or documents 216 or comparing each sentence mathematical expressions of an index of word 212, sentences 213, paragraph 214, section 215, or document 216 mathematical expressions, can be carried out or can be carried out by various means including for example, determining a distance between word, sentence, or paragraph mathematical expression, expressed as vectors, in n-dimensional space where n can be any integer up to about 10,000, for example, 2 to about 10,000, 4 to about 1,000, about 10 to about 1,000, about 20 to about 500, and the like and combinations thereof.

Matched mathematical expressions can be obtained by matching mathematical expressions from two words, sentences, paragraphs, sections, or documents one from a query and one from an indexed document and producing a similarity score between sentences 222, 223, 224, 225, 226, respectively. The similarity score may be computed as the simple cosine similarity between the respective numerical representations (vectors), or the vectors may be used as the input for additional, more sophisticated computational or statistical procedures for computing the similarity score between two or more words, sentences, paragraphs, or documents using, for example, machine learning techniques such as support vector machine (SVM), k-nearest neighbor, and the like. In some embodiments, the similarity score can be applied to an entire query, or in other embodiments, the similarity score can be applied to individual sentences from the query. In some embodiments, the similarity score can be applied to the entire indexed document (document similarity score) 226, sections of the indexed document (section similarity score) 225, paragraphs of the indexed document (paragraph similarity score) 224, individual sentences of the indexed documents (sentence similarity score) 223, or combinations thereof. For example, a sentence mathematical expression or paragraph mathematical expression from a query can be compared to a document mathematical expression or section mathematical expression of documents in an indexed to produce, for example, a sentence/document similarity score or a paragraph/document similarity score.

In embodiments in which similarity scores are obtained for words 222, sentences 223, paragraphs 224, sections 225, and documents 226 and queries, the methods may include comparing the similarity score for each indexed document with the similarity scores for all of the other indexed documents in the database, and ranking the indexed documents in the database based on their similarity score 230. In embodiments in which similarity scores are obtained for paragraphs (paragraph similarity score) 224 or individual sentences (sentence similarity score) 223 of the query and indexed documents, the methods may include the step of combining sentence similarity scores, paragraph similarity scores, or section similarity scores contained within each indexed document to produce a document similarity score. Such methods may further include the steps of comparing the document similarity score for each indexed document with the document similarity scores for all of the other indexed documents in the database, and ranking the indexed documents in the database based on their document similarity score.

The methods of embodiments may include a variety of additional steps or various combinations such additional steps. For example, in some embodiments, such methods may include the step of removing word vectors below a particular threshold, removing all irrelevant characters such as, for example, non-alphanumeric characters, tokenizing text, removing words that are not relevant or important to the context of the query such as “a,” “an,” “the,” and prepositions, converting all characters to lowercase, combining misspelled or alternately spelled words to a single representation, and lemmatizing words, for example. reducing words such as “am,” “are,” and “is” to a common form such as “be”, and the like and combinations thereof. Such steps can be carried out on the query before converting each word of the query to a vector.

The various methods discussed above can be carried out in any order. For example, in certain embodiments, the method may include combining the word mathematical expressions, sentence mathematical expressions, and paragraph mathematical expressions, of a search query to produce a query mathematical expression, which is then compared to document mathematical expressions of indexed documents to identify a subset of documents that have some level of similarity to the query 216. The step of comparing word mathematical expressions 213, sentence mathematical expressions 214, paragraph mathematical expressions 215, and combinations thereof can then be carried out on the subset of documents to provide a more detailed comparison of the remaining documents.

Each word mathematical expression, sentence mathematical expression, paragraph mathematical expression, section mathematical expression or document mathematical expression can be expressed in any way including, for example, integers, fractions, mathematical formulae, geometric formulae, graphs, and the like. In some embodiments, each word mathematical expression, sentence mathematical expression, paragraph mathematical expression, section mathematical expression or document mathematical expression may be represented by a metric graphs, and matching can be carried out as a one-to-one or one-to-many matching to produce a similarity score between the two graphs.

Applying metric graphs to sentences requires preprocessing the query to represent each sentence as a directed graph. Each word in a sentence has a corresponding node in the graph whose features are, for example, a Part-Of-Speech (POS) tag for the word, which is assigned based on the part of speech, e.g., noun, verb, adjective, etc., of each word (or token), a Named Entity (NE) tag of the word, which classifies each word into pre-defined category such as names of persons, names of organizations, names of locations, expressions of times, quantities, monetary values, percentages, etc., or the word itself. Tools such as Stanford POS tagger and named entity recognizer can be used for obtaining such tags. In other embodiments, each word can also be described as a vector within a language model space using, for example, a word2vec system. Relationships between words can be represented by directed edges in the graph which may be defined as, for example, word order edges, dependency edges, and coreference edges. Words that follow each other in the sentence may be connected by word order edges that point from a word to the next. Edges that can be obtained by the dependency parse tree of the sentence is used as dependency edges. Coreferencing words can be connected with bi-directional coreference edges.

In various embodiments, each type of edge may represent a different relationship, and distinct weights for each edge type, which can be determined empirically. In graph representations of sentences, the cost of assigning an object node to a label node can be calculated as a combination of three factors such as, for example, vector representation of the word, its POS tag, and its NE tag. Vector representation of words from language model can be used by calculating the cosine distance between two vectors. In some embodiments, words can be assigned a similarity score according to their dictionary features such as assigning higher similarity if two words are synonyms or hyponyms. In some embodiments, the synonyms and hyponyms may be identified using known thesauruses and in other embodiments a specialized thesaurus may be produced during pre-processing of the indexed documents.

In some embodiments, POS tags and NE tags can be used to determine the similarity score, thereby distinguishing two words that are same but used within different contexts, for example, Apple (the company) and apple (the food). Even though the mathematical expression representation (e.g., a vector) will be the same for both words, their similarity score may low indicating that the terms are used in different contexts. In some embodiments, the POS and NE tags may be appended to the word in both the training and inference stages, resulting in distinct mathematical representations (e.g., vector) for the same word used in different contexts. In some embodiments, a distance measure can be used to calculate the separation cost defined over the graph representation of sentences. In certain embodiments, the reciprocal of the edge weight can be used as the distance measure between two nodes. Since there might be several directed edges from a node “a” to a node “b,” such edges can be represented as a single heavier edge whose weight is the sum of original edges.

The search query of embodiments can be inputted by any means including text input, audio (e.g., voice) input, and the like. In some embodiments, the methods may include processing the input data using various techniques such as, for example, natural language processing, computational linguistics, speech-to-text, automatic speech recognition, artificial intelligence, and the like.

Further embodiments are directed to methods for performing a search using two or more overlapping search queries. In such embodiments, a first search query may be an abstract or other description of an article to be searched in natural written or spoken language of the queries author, and a second search query may be an individual element of the first search query. In some embodiments, greater weight may be given to elements of the second search query when a search is performed on the first search query. In other embodiments, lower weight may be given to elements of the second search query when a search is performed on the second search query.

Such methods can be used in the context of various searches including, for example, Boolean or semantic searches, and in certain embodiments, such methods may be used in the context of a natural language search such as that described above. In the context of the natural language searching methods described above, the weighting effect of the may be given to individual words, sentences, or paragraphs describing the elements in the second search query when word vectors, sentence vectors, paragraph vectors, or document vectors are calculated or when sentence similarity scores, paragraph similarity scores, or document similarity scores are calculated, and may move indexed documents higher or lower, depending on the weighting factor, during ranking of the indexed documents.

The indexed documents of various embodiments may be any type of document, such as, for example, published articles, academic journals, patent publications, issued patents, and the like and various combinations thereof. In some embodiments, the indexed documents may be any document available on the internet. The step of indexing can be carried out using the same methods describe above to produce word mathematical expressions, sentence mathematical expressions, paragraph mathematical expressions, section mathematical expressions, document mathematical expressions, and the like and combinations thereof, corresponding to each word, sentence, paragraph, section, document or combinations thereof in each document of the index. For example, in some embodiments, indexing may include converting each word of each sentence of a document to a mathematical expression to produce a number of word mathematical expressions, combining the word mathematical expressions of a sentence to produce a sentence mathematical expression. In some embodiments, indexing may further include combining each sentence mathematical expression of a paragraph to produce a paragraph mathematical expression for each paragraph of the document, combining each paragraph mathematical expression of a section to produce a section mathematical expression, combining each paragraph mathematical expression or section mathematical expression of the document to produce a document mathematical or any combination thereof.

The indexed documents may be stored locally on, for example, a hard drive or on a server operably connected to the internet. In some embodiments, the documents to be searched may be indexed simultaneously with the search, thereby allowing the search to be carried out on specific documents.

The various steps of the methods described above can be carried out by a processor. For example, embodiments include converting, by a processor, each word of each sentence of a document to a mathematical expression to produce a number of word mathematical expressions, combining, by a processor, the word mathematical expressions of a sentence to produce a sentence mathematical expression, and in some embodiments, combining, by a processor, each sentence mathematical expression of a paragraph to produce a paragraph mathematical expression for each paragraph of the document, combining, by a processor, each paragraph mathematical expression of a section to produce a section mathematical expression, combining, by a processor, each paragraph mathematical expression or section mathematical expression of the document to produce a document mathematical and so on. Thus, the steps of the methods of some embodiments can be carried out by a processing system or computer.

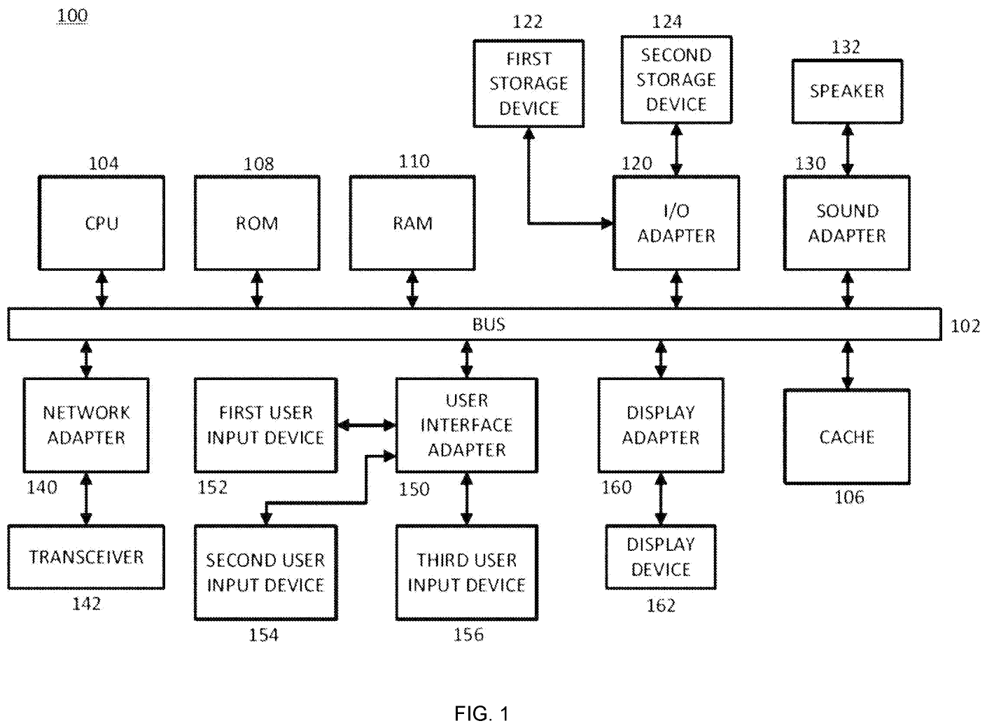

FIG. 1 is an exemplary processing system 100, to which the methods of various embodiments can be may be applied. The processing system 100 may include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, can be operatively coupled to the system bus 102.

A first storage device 122 and a second storage device 124 can be operatively coupled to system bus 102 by the I/O adapter 120. The storage devices 122 and 124 can be any of storage device, for example, a magnetic or optical disk storage device, a solid state magnetic device, and the like or combinations thereof. Thus, storage devices 122 and 124 can be the same type of storage device or different types of storage devices.

In some embodiments, a speaker 132 may be operatively coupled to system bus 102 by the sound adapter 130. A transceiver 142 may be operatively coupled to system bus 102 by network adapter 140. A display device 162 can be operatively coupled to system bus 102 by di splay adapter 160.

In various embodiments, a first user input device 152, a second user input device 154, and a third user input device 156 can operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

The processing system 100 may also include numerous other elements that are not shown, as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method comprising:
processing a first input describing a subject in natural language to produce a first series of vectors;
processing a second input describing an individual element of the subject to produce a second series of vectors;
comparing the first series of vectors to index vectors in an index derived from a database of documents;
identifying documents that include similar vectors to the first series of vectors to produce a first set of documents;
comparing the second series of vectors to the index vectors;
identifying documents that include similar vectors to the second series of vectors to produce a second set of documents;
combining the first set of documents and the second set of documents to produce a relevant set of documents.

2. The method of claim 1, further comprising calculating a difference between the first set of vectors, the second set of vectors, or combinations thereof, and the index vectors to produce a score for each document of the first set of documents, each document of the second set of documents, or combinations thereof.

3. The method of claim 1, wherein processing comprises converting each word of each sentence of the first input, the second input, or combinations thereof to a vector to produce the first series of vectors, the second series of vectors, or combinations thereof.

4. The method of claim 3, further comprising plotting the first series of vectors, the second series of vectors, or combinations thereof in vector space.

5. The method of claim 1, further comprising converting each word of each sentence of each document of the database of documents to a vector to produce the index vectors.

6. The method of claim 5, further comprising plotting the index vectors in vector space.

7. The method of claim 1, further comprising scoring the first set of documents and the first input to produce a series of first similarity scores, scoring the second set of documents and the second input to produce a series of second similarity scores, or combinations thereof.

8. The method of claim 7, further comprising multiplying the series of first similarity scores by a first weighting factor to produce a series of first weighted similarity scores, multiplying the series of second similarity scores by a second weighting factor to produce a series of second weighted similarity scores, or combinations thereof.

9. The method of claim 8, wherein the first weighting factor and the second weighting factor are the same.

10. The method of claim 8, wherein the first weighting factor and the second weighting factor are different.

11. The method of claim 8, wherein combining the first set of documents and the second set of documents to produce a relevant set of documents comprises ordering the series of first weighted similarity scores and the series of second weighted similarity scores and identifying the documents associated with each of the series of first weighted similarity scores and the series of second weighted similarity scores.

12. The method of claim 1, wherein the first input is an abstract or other description of an object, article, apparatus, compound, method, or combinations thereof.

13. The method of claim 1, wherein the first input, the second input or combination thereof is a written language, a spoken language, or combinations thereof.

14. The method of claim 1, wherein the second input comprises a detailed description of the individual element of the first input.

15. The method of claim 1, wherein the database of documents comprises published articles, academic journals, patent publications, issued patents, and combinations thereof.

16. The method of claim 1, wherein identifying documents that include similar vectors to the second series of vectors to produce the second set of documents is carried out before identifying documents that include similar vectors to the first series, and identifying documents that include similar vectors to the first series of vectors is carried out on the second set of documents.

17. The method of claim 1, wherein identifying documents that include similar vectors to the second series of vectors is carried out on the first set of documents.

18. A query comprising:
a first input describing a subject in natural language; and
a second input describing an individual element of the subject.

19. The query of claim 18, wherein the first input, the second input or combination thereof is a written language, a spoken language, or combinations thereof.

20. The query of claim 18, wherein the second input comprises a detailed description of the individual element of the first input.
